(19) United States
(12) Patent Application Publication
(10) Pub. No.: US 2007/0200873 A1
(43) Pub. Date: Aug. 30, 2007

(54) PIXEL AND VECTOR LAYER INTERACTION

(75) Inventor: Siu Chi Hsu, Hong Kong (CN)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/276,390

(22) Filed: Feb. 27, 2006

(51) Int. Cl. G09G 5/00

(52) U.S. Cl. 345/629

(57) ABSTRACT

A single graphics design application may provide both a vector object editor and a pixel editor. The application may automatically convert a graphic of a first type (e.g., vector or pixel) to a second type (e.g., pixel or vector) when copied to a layer having a mode of the second type. A layer for manipulation of a particular type of graphic (e.g., pixel data or vector) may be provided to the user based on input from the user. The layer may provide editing tools that are appropriate for the layer mode. A graphic that is automatically converted from a first type to a second type may be converted back to the basis graphic based on input from the user. The conversion may be based on reversing manipulations performed on the received graphic in the layer to convert the current graphic back to the original received graphic.

### BACKGROUND

Producers of graphic content for display using a computer system want to create rich graphic contents which can be manipulated for different uses. Graphic contents are generally represented in two ways or types: as pixel data, possibly in layers, in the form of a bitmap image; or as a collection of analytical graphic objects, often referred to as “vector objects”, in a vector document. Pixel data are collections of one or more pixels, which are samples of color and/or other information including transparency, thickness etc. An example of pixel data is a digital photograph, with a fixed resolution. Another graphic type is a vector object. A vector object is an abstract graphic entity such that its appearance, position, and orientation in the picture space are described analytically through geometrical formulae and other arbitrary information (e.g., color, gradient, 3D coordinates, and the like.) Pixel data with additional position and orientation information attached specifying the spatial relationship of its pixels relative to a picture space containing the image, is considered a bitmap vector graphic object when it is placed in vector picture document. Such a bitmap vector object, before the application of additional transformation or deformation, is equivalent to a rectangular vector object texture-mapped to the pixel data.

Vector graphic documents are sometimes considered more flexible than pixel data because they can be re-sized and stretched without pixellation effects because of the analytical and therefore resolution independence nature of vector objects. Additionally, graphics stored as vector objects may have a ‘better’ appearance on a higher-resolution display device, whereas pixel data appear the same regardless of the device's resolution due to their fixed initial sampling resolution. In addition, vector objects may also require less memory storage than pixel data. On the other hand, pixel data editing tools typically allow free and unstructured pixel level manipulations, such as smudging, blurring, live filter effects, and the like, which may not be available to vector based objects.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Generally, many graphics design applications are dedicated to a single graphics type, such as either pixel data or vector based objects. Some graphics design applications support both graphics types; however, these design applications typically are biased toward supporting one type or another. Moreover, graphics design applications which provide both pixel data and vector object manipulation typically allow only a single vector object in each layer. In this manner, multiple vector objects must be placed in separate layers, increasing complexity in picture document generation and modification. Moreover, graphics applications which provide both pixel data and vector object manipulation typically have inadequate indication of the type of graphics being edited. For example, mere display of the graphics or even its associated layer may not indicate to the graphics producer whether the graphics type is pixel data or a vector based object. Moreover, even if the graphics type is identified as pixel data or a vector based object, all tools for modifying both graphics types may be displayed. Moreover, since some tools vary in function when applied to either pixel data or vector object, the user may not have a clear indication of how the tool will function when applied to a displayed graphic.

To handle multiple graphics types in a single picture document, a single graphics manipulation application may provide a separate editing environment mode, with each mode tailored for a single graphics type. The different editing environments of different modes may be provided to the user as separate layers, which may be selectable by the user. Selection of a layer of a particular mode (e.g., pixel, vector) may trigger the graphics application to provide suitable editing tools and/or functionality for the displayed graphics type of that layer mode, and/or may remove editing tools and/or functionality for graphics types that are not of that layer mode. For example, a pixel data editing environment and a vector object editing environment may be provided as a pixel layer and a vector layer. As used herein the pixel data environment provides functionality and one or more editing tools for editing a collection of pixels. The vector object editing environment, as used herein, provides functionality and one or more editing tools editing a vector object, including any vector object-based graphic entities, including curves, lines, more complex objects like 3D models, and the like.

In some cases, a graphics of one type transferred from one layer of one mode to a target layer of another mode may be automatically converted from the one graphics type to a target graphics type matching the target mode. For example, copying or moving a vector object from a vector mode layer to a pixel mode layer may automatically convert the copied or moved vector object to pixel data. Similarly, transferring a selection of pixels from a pixel mode layer to a vector mode layer may automatically convert the copied or moved pixels to a vector object.

A target graphic that is automatically converted from one type to another type may retain the type and/or other information of the basis graphic. The basis graphic type and/or information may be accessed in response to an indication by the user to convert the graphic back to the previous type or access the basis graphic. For example, a user may double-click on a vector object that was converted from pixel data to access the original pixels of the basis pixel data. In one example, the basis pixel data may be accessed by converting the target vector graphic back to the type and form of the basis pixel data.

In response to the conversion to the basis graphics type, the single graphics application may provide suitable tools and/or functionality for that graphics type and/or remove tools that are not suitable for that graphics type. The accessed basis graphic may be modified and may be automatically converted back to the target graphic type of the associated layer mode and may incorporate the modifications of the basis graphic.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is an example computing system for implementing a graphics design application;

FIG. 2 is an example display screen of a vector object from a graphics design application;

FIG. 3 is an example display screen of a modified vector object of the vector object of FIG. 2;

FIG. 4 is an example display screen of converted pixel data of the vector object of FIG. 2;

FIG. 5 is an example display screen of the vector object of FIG. 2, the modified vector object of FIG. 3, and the converted pixel data of FIG. 4;

FIG. 6 is an example display screen of pixel data from a graphics design application;

FIG. 7 is an example display screen of a converted vector object of the pixel data of FIG. 6;

FIG. 8 is an example display screen of the basis pixel data of the converted vector object of FIG. 7;

FIG. 9 is an example display screen of modifying the basis pixel data of FIG. 8;

FIG. 10 is an example display screen of the converted vector objects of the basis pixel data of FIG. 9;

FIG. 11 is an example display screen of a vector object converted from pixel data;

FIG. 12 is an example display screen of the vector object of FIG. 11 modified with warping;

FIG. 13 is an example display screen of the vector object of FIG. 12 converted to the basis pixel data;

FIG. 14 is an example display screen of modifying the basis pixel data of FIG. 13;

FIG. 15 is an example display screen of the vector object of FIG. 11 incorporating the modified basis pixel data of FIG. 14; and

FIG. 16 is a flow chart of an example method of bitmap and vector layer interaction.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a graphics design system, the system described is provided as an example and not a limitation. As those skilled in the art will appreciate, the present examples are suitable for application in a variety of different types of object editing systems.

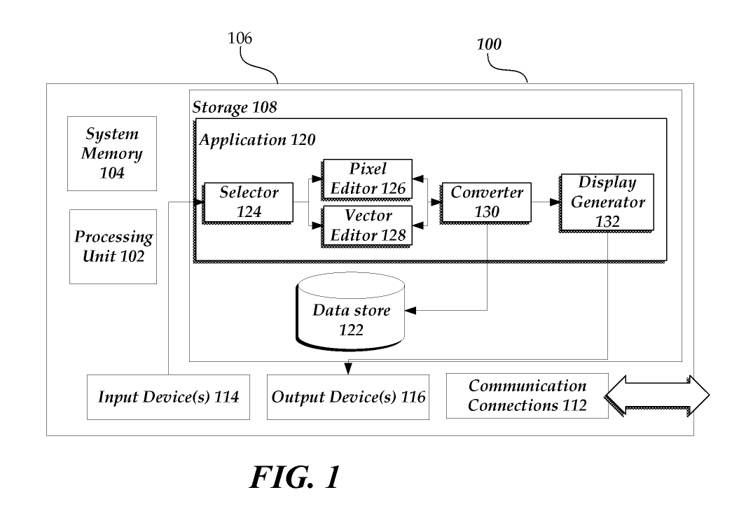

FIG. 1 and the following discussion are intended to provide a brief, general description of a graphics design system 100. As shown in FIG. 1, a graphics design system 100 may be provided by one or more computing devices 106. Computing device 106 of FIG. 1 and the following discussion are intended to provide a brief, general description of a suitable computing environment in which all or a portion of a graphics design system may be implemented. The operating environment of the computing device 106 of FIG. 1 is only one example of a suitable operating environment and is not intended to suggest any limitation as to the scope of use or functionality of the operating environment. Other well known computing systems, environments, and/or configurations that may be suitable for use with a graphics design system 100 described herein, include, but are not limited to, personal computers, server computers, hand-held or laptop devices, multiprocessor systems, micro-processor based systems, programmable consumer electronics, network personal computers, mini computers, mainframe computers, distributed computing environments that include any of the above systems or devices, and the like.

In its most basic configuration, computing device 106 typically includes at least one processing unit 102 and memory 104. Depending on the exact configuration and type of computing device, memory 104 may be volatile (such as RAM), non-volatile (such as ROM, flash memory, etc.) or some combination of the two.

Additionally, device 106 may also have additional features and/or functionality. For example, device 106 may also include additional storage 108 (e.g., removable and/or non-removable). Computer storage media includes volatile and nonvolatile, removable and non-removable media implemented in any method or technology for storage of information such as computer readable instructions, data structures, program modules, or other data. Memory 104 and storage 108 are examples of computer storage media. Computer storage media includes, but is not limited to, RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which can be used to store the desired information and which can be accessed by device 106. Any such computer storage media may be part of memory 104 and/or storage 108.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Device 106 may contain one or more communication connection(s) 112 that allow the device 106 to communicate with other devices, such as with other computing devices through a network (not shown). Communications connection(s) 112 is an example of communication media. Communication media typically embodies computer readable instructions, data structures, program modules or other data in a modulated data signal such as a carrier wave or other transport mechanism and includes any information delivery media. The term ‘modulated data signal’ means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media.

Device 106 may have one or more input device(s) 114 such as keyboard, mouse, pen, stylus, voice input device, touch input device, laser range finder, infra-red cameras, video input devices, and/or any other input device. Output device(s) 116 such as one or more displays, speakers, printers, and/or any other output device may be included.

Although not required, the graphics design system will be described in the general context of computer-executable instructions, such as program modules, being executed by one or more computers or other devices. Generally, program modules include routines, programs, objects, components, data structures, etc., that perform particular tasks or implement particular abstract data types. Typically, the functionality of the program modules may be combined or distributed as desired in various environments.

The computing device 106 of the graphics design system may include one or more modules stored in any suitable manner, such as in the memory 104 and/or in the storage 108. As shown in the example of FIG. 1, the storage 108 may contain (or contain a reference to) modules for implementing the graphics design system such as a single application 120 and a data store 122.

The single graphics design application 120 may provide one or more of a selector 124, a pixel editor 126, a vector editor 128, a converter 130, and/or a display generator 132. Although separate components are provided for the selector, pixel editor, vector editor, converter, and display engine, it is to be appreciated that the single graphics design application may provide any number of components in any format to provide the functionality discussed herein.

In one example, the selector 124 receives a layer mode indicator input from the user through the input device 114. The layer mode indicator may be any suitable indicator of the layer mode. The layer mode defines the type of graphic that may be manipulated within that layer, e.g., vector objects would be manipulated within a vector mode layer and pixel data (one or more pixels) would be manipulated within a pixel mode layer. Although the following examples describe manipulations and conversions between vector objects and pixel data, it is to be appreciated that other graphics types may be incorporated in a similar manner.

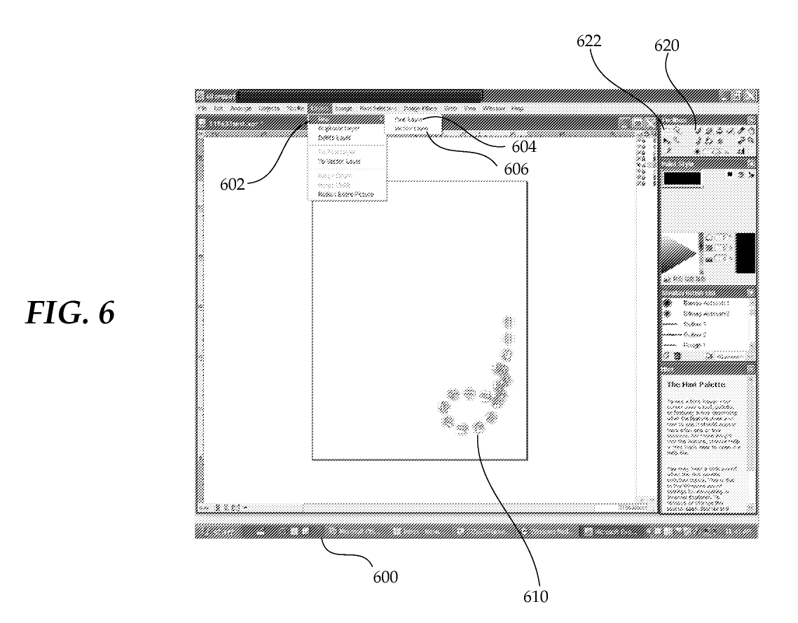

For example, as shown in the example display 600 of FIG. 6, the user may select a menu option to create a new layer 602 and indicate whether the layer should have a pixel mode 604 or vector mode 606. Although a drop down menu is shown in FIG. 6, it is to be appreciated that the user may indicate the new layer mode in any suitable manner, such as through a user interface like a button, text box, keyboard key combination, copying of an object type into an undefined layer, and the like. The layer mode indicator may indicate the desired mode (e.g., vector mode, pixel mode) and may be communicated to the selector in any suitable manner such as with a value, string, switch, trigger, and the like.

In response to the user indication of a layer mode with a layer mode indicator, the selector 124 of FIG. 1 selects the appropriate editor to match the indicated mode of the layer. For example, if a vector mode layer is indicated by the layer mode indicator, then the selector may select the vector editor 128. Similarly, if a pixel mode layer is indicated by the layer mode indicator, then the selector may select the pixel editor 126.

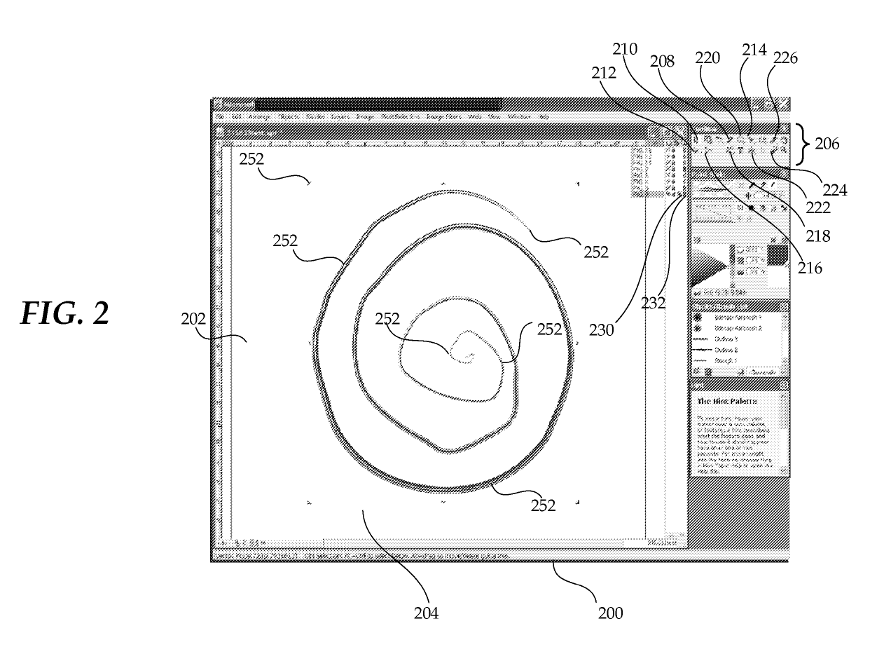

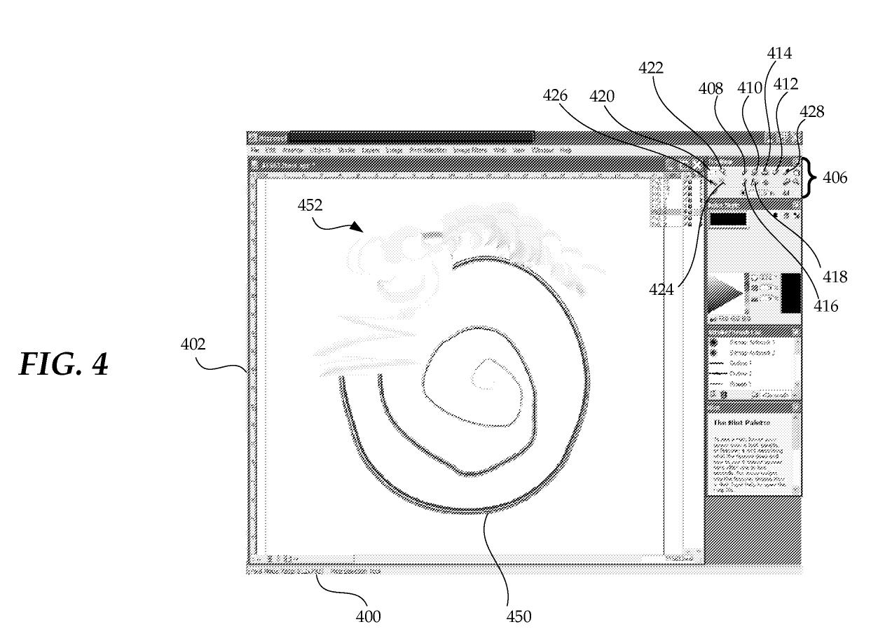

In response to selection by the selector, the appropriate editor (vector editor or pixel editor) may provide an object manipulation frame for manipulation of one or more graphics of the type defined by the mode and may be displayed to the user through the display generator 132 and the output device 116. For example with reference to the example display 200 of FIG. 2, the vector editor 128 may provide a frame 202 with a workspace 204 for creation and/or modification (i.e., manipulation) of vector based objects. Similarly, with reference to the example display 400 of FIG. 4, the pixel editor may provide a frame 402 with a workspace 404 for creation and/or modification (i.e., manipulation) of pixel data. Although in the examples discussed herein, the vector object manipulation frame and the pixel data manipulation frame appear similar, it is to be appreciated that the frame displayed and provided for object manipulation may be selected and provided based on predetermined preferences and/or the indicated layer mode. For example, a vector mode object manipulation frame may be provided with a background grid, etc. whereas a pixel mode object manipulation frame may not provide the grid. But rather provide a checker background showing transparent pixels, and the like.

To allow manipulation of objects, the editors (pixel editor 126, vector editor 128) may provide one or more mode tools and functionalities such as through a tool bar, toolbox, and/or palette which is tailored to the mode of the selected layer. For example, the vector editor may provide vector tools and functionalities appropriate for vector object manipulation, and the pixel editor may provide pixel tools and functionalities appropriate for pixel data manipulation.

With reference to the vector mode layer of display 200 of FIG. 2, the vector toolbox 206 may provide one or more selectable tools to generate and/or modify a vector object. Any number or type of vector manipulation tools may be provided including node tools, such as node selection tool 212, add node tool 214, node converter tool 216, and the like; vector object tools such as vector object selector 210, vector object drawing tool 208, spline tool 218, shape tool 220, cut path tool 222, and the like; color tools such as the gradient tool 224, eye dropper tool 226, and the like; and any other suitable tool for manipulating vector based objects. The vector object selector may allow the user to select one or more objects in the document, in one or more layers. The user may use the vector object select tool to select the object, or drag a marquee over one or more objects to select them. In some cases, the marquee does not have to surround the entire object to select the entire object. For example, the marquee may just touch a portion of the object to select the entire object. In another example, the marquee may be required to surround the entire vector object to select the vector object. In this manner, the marquee may select only those vector object(s) completely within the marquee and not select those objects that are only partially or not completely within the marquee. The node selection tool may allow the user to select one or more individual nodes on a vector path. To select a node, the node selector tool may be used to click on the node. Additionally or alternatively, a marquee having a geometric shape or hand-drawn shape (e.g., lasso) may be used to select one or more individual nodes of one or more objects. The add node tool 214 may allow the user to add points on a path of a vector object. To add a node, the add node tool may be used to click on a path segment where a node doesn't currently exist. The shape of a Bezier path may not be affected by adding a node, however, adding a node to a B-spline curve may change the path's shape. The convert node tool 216 may allow a user to convert one type of path node to another. For example, when a user clicks on a B-spline node with the convert node tool, the node may change to a corner point. In another example, when a user uses the convert node tool to click on a corner point and the two adjacent nodes are also corner points, the node turns to a B-spline curve node.

In another example, when a user uses the convert node tool to click on a Bezier smooth or symmetrical point, the node fully retracts the control handles, becoming a corner point. In another example, when a user uses the convert node tool to click-and-drag on any sort of Bezier node, the handles may extend and become a symmetrical point. In another example, a user may use the convert node tool to drag a control handle of a symmetrical point to unconstrain the node and move the handles independently. In another example, a user may use the convert node tool to drag a control handle of an unconstrained or cusp node to turn the node into a symmetrical point. The spline tool 218 may allow a user to draw a B-spline path, which may provide some functionality over a Bezier path. The spline tool may be used to click for a location of a control point, but based on the B-spline vector algorithm, the resulting curve may or may not pass through the node. The shape tool 220 may be used to create one or more shapes such as ellipses, rectangles, stars, lines, and the like. The cut path tool 222 may be used to split an open path into two or more separate paths, or split a closed path to become an open path. The gradient tool 224 in vector mode may allow control of a gradient's starting and ending points as well as its angle. Once a fill type is chosen, the gradient may be added by clicking and dragging the color across the selection. The eye dropper tool 226 may allow a user to ‘pick up’ the fill color or stroke color from an object or area so that the color can be copied to other objects or used to load a brush. In one example, in vector mode, to copy the fill color from object to another, the eye dropper tool may be used to click on the fill area of the first object, then, while the mouse button is down, the tool may be dragged to the second object. If the mouse is released over the fill area of the second object, the eye dropper tool may fill the second object with the fill color of the first object. If the mouse is released over the stroke area of the second object, the eye dropper tool may fill the second object with the fill color of the first object.

In another example, with reference to the pixel layer of display 400 of FIG. 4, the pixel toolbox 406 may provide one or more selectable tools to generate and/or modify (i.e., manipulate) pixel data. Any number or type of pixel manipulation tools may be provided including drawing tools such as draw tool 408, pencil tool 416, clone brush 414, eraser 412, smudge tool 410, and the like; color tools such as a color fill tool 418, eye dropper tool 428, gradient tool 430, and the like; selection tools such as the pixel select tool 420, pixel lasso tool 422, color based pixel selector 424, and the like; and any other suitable tool for manipulating pixel data such filters, remove red eye, etc. The draw tool 408 may allow a user to paint pixels on a pixel mode layer. The pencil tool 416 may allow a user to edit icons or other pixel data images that require pixel-level detail. The clone brush tool 414 may allow a user to copy pixels from one area of a pixel layer to another based on brush strokes in the new area. The eraser tool 412 may allow a user to paint away or make transparent areas of a pixel layer or the pixel data being edited. The smudge tool 410 may allow a user to smear pixels on a pixel layer as though they were wet paint. The color fill tool 418 may allow a user to fill areas of a pixel layer with the current color. The eye dropper tool 428 in pixel mode may allow a user to ‘pick up’ the fill or stroke color from a pixel area so that the color can be copied to other pixel areas or used to load a paint brush. In pixel mode, the eye dropper tool may be used to click on a pixel to load color of the selected pixel as the current pixel painting color. The gradient tool 430 in pixel mode may allow a user to fill a selection (or an entire pixel layer if there is no current selection) with a solid color, a gradient, or an image fill. The pixel select tool 420 may allow the user to create a marquee shape to select a shaped area of pixels. After selection, the pixel select tool may be used to move the selection to a different location by dragging inside the selection area. The pixel lasso tool 222 may allow a user to draw non-rectangular marquees to select a plurality of pixels in a pixel mode layer. The color based pixel selector 224 may be used to select a plurality of pixels having a similar color in proximity to each other within a pixel layer.

Although one or more displayed tool indicators may be similar for both the vector and pixel modes, the functionality of those tools may vary according to what is appropriate for that mode. For example, the vector object selector tool 210 and the pixel select tool 420 appear identical as arrows. However, with the vector object selector tool, a user may click on a vector object to select the entire vector based object, even though portions of the object are not under a displayed mouse indicator or other user input device tool indicator such as a stylus. In contrast, with the pixel select tool, a user may click and drag over the pixels desired to be selected. Pixels not delimited by the click and drag marquee are not selected by the pixel select tool. In contrast, if a marquee is used in vector mode, the entire object may be selected even though portion(s) of the object lie outside the delimited marquee or alternatively, objects not entirely within the marquee may not be selected even though a portion may lie within the marquee. In another example, the gradient tool in vector mode operates differently than the gradient tool in the pixel mode.

In the workspace of the displayed layer, the user may use one or more tools to generate a graphic. The graphics type created within that workspace is defined by the mode of the layer. For example, in a vector mode layer, graphics generated within the workspace are vector objects; similarly, in a pixel mode layer, graphics generated within the workspace are pixel data.

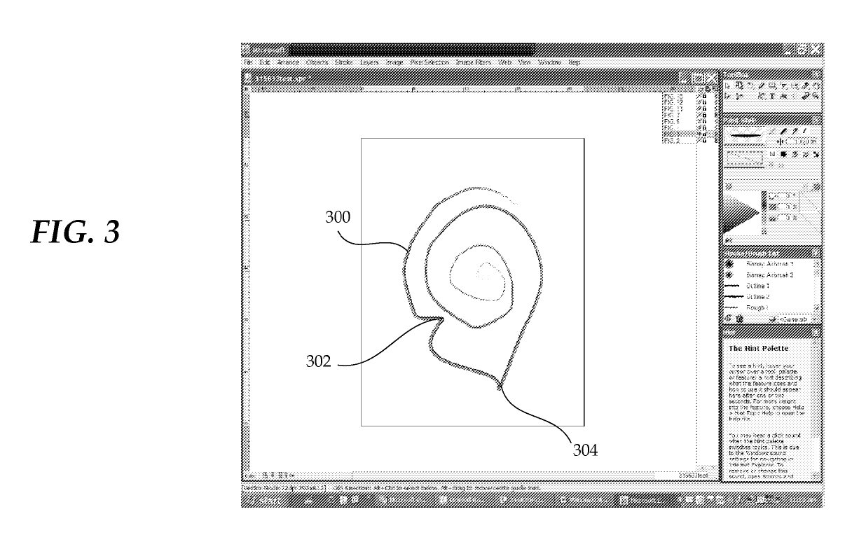

FIGS. 2-3 illustrate examples of a generated vector object. FIG. 2 illustrates a vector workspace 204 of a vector mode layer. The vector mode layer may be indicated to the user in any suitable manner such as through the appropriate vector toolbox display 206, layer selection indicator which in FIG. 2 is illustrated as a highlight 230 of the layer, and a vector layer mode identifier 232 which is illustrated as a rectangle. It is to be appreciated that the layer selection indicator, the layer mode identifier, and mode tools may be provided and displayed to the user in any suitable format including any combination or permutation of an audible signal, a background coloring, frame coloring, frame shape, and the like.

In the workspace 204 of FIG. 2, the user has used the vector drawing tool 208 to create a spiral 250 including a plurality of nodes 252 defining the points of manipulation of the vector based object of the spiral. The user may select the entire vector object spiral 250 and drag or move the spiral object to alternative locations in the workspace such as by using the vector object selection tool 210. The user may select one or more nodes of the vector based object spiral 250 and manipulate the location of individual nodes of the object. For example, as shown in the vector based object 300 of FIG. 3, the spiral 250 of FIG. 2 has been modified by moving nodes 302 and 304 out of the spiral. Since the spiral is a vector based object in a vector mode layer, the object 300 is displayed with a continuous line defined by the nodes, in contrast to pixel editing which would have moved the selected pixels at the nodes without affecting the rest of the spiral.

With reference to FIG. 1, the single graphics design application 120 may provide a converter 130 which may automatically convert a graphic of one type to another type automatically upon a trigger or indicator provided by the user. For example, a vector object of a vector mode layer may be automatically converted to pixel data in response to a user indication, such as transferring (which include copying, moving, importing, and the like) a vector object to a pixel mode layer, and the like. Similarly, pixel data of a pixel mode layer may be automatically converted to a vector object in response to a user indication, such as transferring pixel data from a pixel mode layer to a vector mode layer.

In one example, selection of a target vector object based on converted pixel data may convert the target vector object back to its basis pixel data and a pixel editor frame may be opened to edit the basis pixel data. In some cases, exiting the pixel data editor frame may automatically convert the basis (and possibly modified) pixel data to the target vector object and may incorporate changes in the basis pixel data and/or features of the vector object before modification of the basis pixel data.

For example, the vector object spiral 250 of FIG. 2 may be selected and transferred over to a new pixel layer such as the pixel mode layer illustrated in the example display 400 of FIG. 4. Specifically, the user may copy the vector object spiral 250 over to the pixel mode layer workspace 404. The copying of a vector layer object to a layer having an alternative mode (i.e., pixel mode) may trigger the converter 130 of FIG. 1 to convert the vector object to pixel data, such as a pixel spiral. As noted above, the pixel editor associated with the pixel mode layer may provide tools and functionality appropriate for pixel data manipulation. For example, as shown in FIG. 4, the smudge tool 410 may be used to smudge a portion 452 of the pixel spiral 450. In this manner, the vector object 250 may be converted to pixel data 450 and manipulated as pixel data. The automatic conversion of a graphic based on the associated mode of the destination or target layer may reduce user action to convert a graphic.

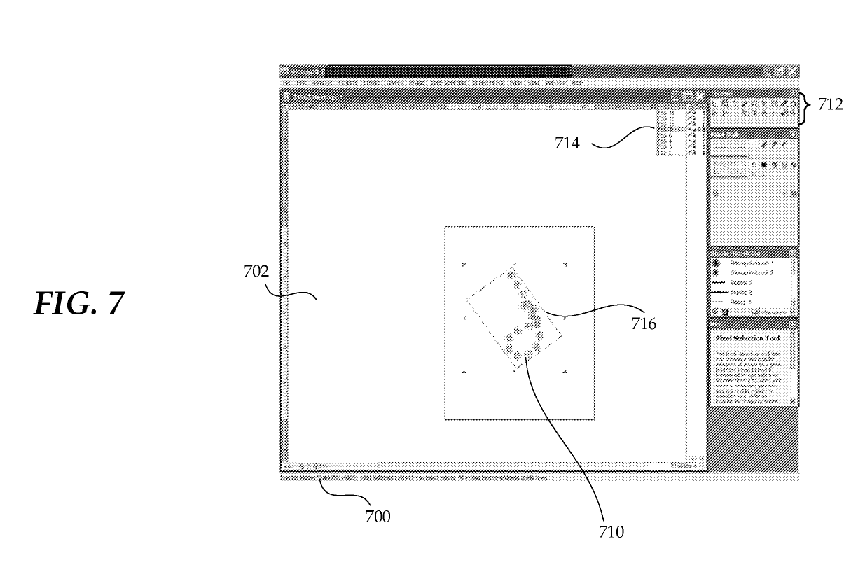

In another example, a pixel mode layer may be used to manipulate pixel data (e.g., create, modify, etc.). An example display 600 of a pixel mode layer with pixel data 610 is illustrated in FIG. 6. Specifically, the drawing tool 620 was used to create the pixel data squiggle 610. The pixel data squiggle 610 may be selected such as by using the pixel selection tool 622 to draw a marquee around the squiggle 610 and the pixel data may be transferred, such as by clicking and dragging, to a vector mode layer. An example vector mode layer is illustrated in the display 700 of FIG. 7. Pixel data may be converted to a vector object in any suitable manner. For example, the pixel data may be associated with one another to form a bitmap object that may be manipulated as a planar object. In another example, pixel data may be examined and converted to a vector graphic, such as by using a recognition of lines, shapes, and other vector object, such as by using optical character recognition or other conversion. In this example, the pixel squiggle 610 of FIG. 6 was copied and pasted into the workplace 702 of the vector mode layer of FIG. 7 to form the vector object 710.

In response to the user indicating copying of pixel data into a vector mode layer, the converter 130 of FIG. 1 may compare the received graphics type with the mode of the target layer. If the graphics type and layer mode do not match, the converter may automatically convert the received graphic to have a type that matches the mode of the target layer. A vector object may be converted to pixel data in any suitable manner. For example, the individual pixel color and other pixel information of the displayed vector graphic may be stored as individual pixel data. In this example, the pixel data squiggle 610 is automatically converted to a bitmap vector object squiggle 710 delimited by the vector object frame 716 in the vector layer of FIG. 7. In this manner, before accomplishing the paste operation indicated by the user, the converter converts the type of graphic to match the mode of the indicated target layer.

After conversion of the graphic to a graphics type (e.g., pixel, vector, and the like) to match the mode of the target layer, the newly converted target graphic may be displayed, such as by the display generator 132 of FIG. 1 in the workspace of the target layer. The appearance of the displayed vector object may be identical to the basis pixel data except for graphics type. In this manner, the new object, such as vector object squiggle 710 may be manipulated as a vector object. For example, as shown in FIG. 7, the vector object 710 may be selected as entire bitmap vector object using a vector object selection tool and rotated.

In some cases, the single graphics application 120 of FIG. 1 may retain the basis graphics type and/or other object information associated with the converted graphic. The associated basis graphic type and/or other information may be stored in any suitable manner and/or format such as in data store 122 of FIG. 1. the graphic type and/or any other information may be associated with the displayed or current graphic in any suitable manner in the data store.

It is to be appreciated that any suitable data store in any suitable format may be used to store and/or communicate the object information, manipulation information, and the like to the graphics design system 100, including a relational database, object-oriented database, unstructured database, an in-memory database, or other data store. A storage array may be constructed using a flat file system such as ACSII text, a binary file, data transmitted across a communication network, or any other file system. Notwithstanding these possible implementations of the foregoing data stores, the term data store and storage array as used herein refer to any data that is collected and stored in any manner accessible by a computing device.

For example, if pixel data is converted to a vector object, the single graphics design application may retain information that the resulting vector object is based on pixel data with a basis graphic indicator, may retain information regarding the basis graphic itself with basis pixel data information. For example, basis graphic information may include any suitable graphic information including the associated basis pixel data itself, location of the basis pixel data, a list of the graphic manipulations executed on the target vector object to manipulate the basis pixel data to the current displayed graphic, and the like.

In the example of converted target vector object 710 of FIG. 7, the user may select the vector object 710 and provide a basis graphic indicator. The basis graphic indicator may indicate a request to the graphics design application to access the basis pixel data used in the prior conversion of pixel data to the present selected vector object. The basis graphic indicator may be any suitable indicator such as double-clicking a selected object, selecting a menu option, selecting the graphics with a basis graphic access tool, and the like.

In response to the basis graphic indicator, the converter may automatically convert the selected graphic to the previous or basis graphic type. For example, in the example of FIG. 7, the converter may convert the current vector object 710 back to a pixel data type. In some cases, the converter may convert the current graphic to not only the basis graphics type, but also may convert or allow access to the basis graphics of the current displayed graphic. In the example of FIG. 7, the converter may convert the current vector object 710 back to pixel data 610. For example, the converter 130 of FIG. 1 may retrieve from the data store 122 the manipulations associated with the current graphic that were executed against the basis pixel data which resulted in the target vector graphic object and/or any modifications made to the target graphic resulting in the current displayed and selected vector object. In this manner, those manipulations specifically executed against the target object may be retrieved from the data store, even if intervening manipulations were accomplished in other editing sessions, to other graphics, to other graphics in other layers, and the like. In the example of vector object 710, the data store may retain information indicating that the basis pixel data 610 was converted to a target vector object and rotated counter-clockwise a certain number of degrees with a vector object manipulation. The converter may then reverse the manipulation process (e.g., undo the vector object manipulations) to convert the vector object to the basis pixel data. For example, the converter may take the vector object 710, rotate the vector object in the clock-wise direction for the certain number of degrees, and then convert the vector object into basis pixel data, which should then be identical to the pixel data 610 of the originating pixel data of the target vector object. Alternatively, the converter may examine the vector object and retrieve from the data store the associated basis pixel data for the selected vector object.

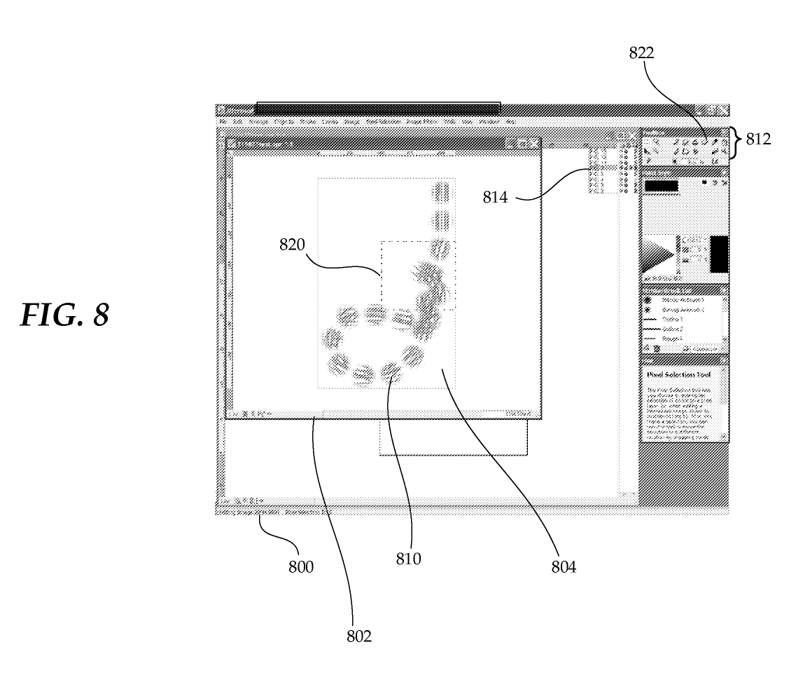

After conversion of the graphic, the selector 124 of FIG. 1 may select the appropriate editor to match the type of the basis graphic and the basis graphic may be displayed to the user in any suitable manner for manipulation, such as through the appropriate editor and/or graphics generator. For example, as shown in the example display 800 of FIG. 8, the basis pixel data 810 may be displayed to the user in a basis manipulation frame having a basis graphic manipulation workspace 804. The basis manipulation frame may provide any suitable display and/or manipulation environment for the user through the selected editor. For example, as shown in FIG. 8, the basis manipulation frame 802 provides a pixel mode editing environment or layer that may be provided by the pixel editor 126 of FIG. 1.

In response to the basis graphic indicator, the editor, such as the pixel editor may provide the appropriate tools for the type of the accessed basis graphic, which in the case of the basis graphic 810 would be the pixel manipulation tools. The basis graphic manipulation tools may be provided to the user in addition to or instead of the layer mode manipulation tools. For example, as shown in FIG. 8, the pixel manipulation toolbox 812 containing the pixel manipulation tools replaces the vector object manipulation toolbox 712 of FIG. 7, even though the active layer is a vector model layer as indicated by the layer indicator 714, 814. In this manner, the pixel editor and/or vector editor may provide tools which match the graphic type of the selected layer mode as noted above and/or tools which match the graphic type of an accessed basis graphic which may be different than the mode of the current layer.

In the basis manipulation frame, the user may manipulate the basis graphic within a mode that is different than the mode of the current layer. For example, as shown in FIG. 8, the selected layer mode is a vector mode, however, the user may manipulate the accessed basis pixel data as if it was within a pixel mode. In this manner, a functional layer of one type (e.g., pixel workspace 804 of FIG. 8) may be embedded within a layer of another mode type (e.g., vector workspace 702 of FIGS. 7 and 8), all being provided by the single graphics application 120.

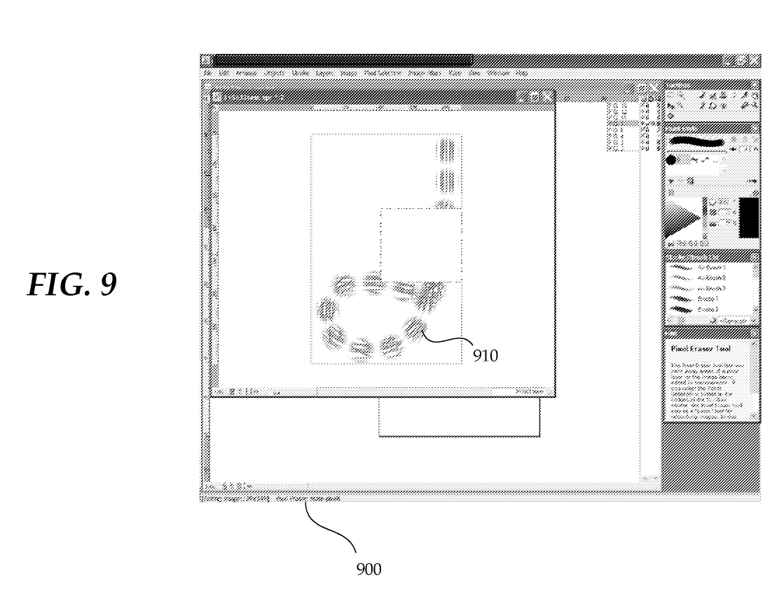

For example, with reference to FIG. 8, the user may draw a marquee 820 over a portion of the pixel data 810 selecting the delimited portion of the pixels of the pixel data 810. The user may then select the eraser tool 822 and erase the pixels delimited by the marquee. As result, the basis pixel data may be modified to the basis pixel data 910 illustrated in the example display 900 of FIG. 9.

After access (and optional manipulation) to the basis pixel data is completed, the user may provide a current graphic indicator in any suitable manner. The current graphic indicator may indicate a request to the graphics design application to quit access to the basis pixel data and return to the manipulation of the current vector object. The current graphic indicator may be any suitable indicator such as double-clicking the basis pixel data, closing the basis graphic manipulation frame, selecting a menu option, selecting the basis graphic with a current graphic access tool, selecting the current graphic in the workspace of the target layer, selecting the workspace of the target layer, and the like.

In response to the current graphic indicator, the modified basis graphic may be automatically converted in any suitable manner back to the graphics type of the current object, such as by the converter 230 of FIG. 1. For example, the converter may convert the modified basis graphic to a graphic having a type matching the mode of the current layer (e.g., converting basis pixel data 910 to a vector object). The converter 130 may retrieve from the data store 122, the manipulations executed against the basis graphic which resulted in the target and current object (and prior to accessing the basis object through the current object). In the example of pixel data 910 of FIG. 9, the converter may retrieve the manipulations which converted the pixel data 610 of FIG. 6 to the target vector object and the modifications to the target vector object 710 of FIG. 7. Specifically, the converter may convert the modified basis pixel data 910 to a vector object and rotate counter-clockwise the certain number of degrees with a vector object manipulation.

In another example, each modification to the basis graphic object may be reflected in the current object, in the target object layer immediately. To display the modification of the basis graphic object in the current object, the converter, in response to an indication of a modification of the basis graphic object, may retrieve from the data store 122, the stack of manipulations executed against the basis graphic which resulted in the target and current object (and prior to accessing the basis object through the current object). In this manner, the current graphic indicator may be an indication of a modification of basis graphic object. In the example of pixel data 910 of FIG. 9, the converter may retrieve the manipulations which converted the pixel data 610 of FIG. 6 to the target vector object and the modifications to the target vector object 710 of FIG. 7. Specifically, the converter may convert the modified basis pixel data 910 to a vector object and rotate counter-clockwise the certain number of degrees with a vector object manipulation. The modified current graphic may then be displayed in the target layer. In this manner, each modification to the basis graphic may be immediately transferred to the current graphic object by repeating the stack of retrieved manipulations on the newly modified basis graphic object.

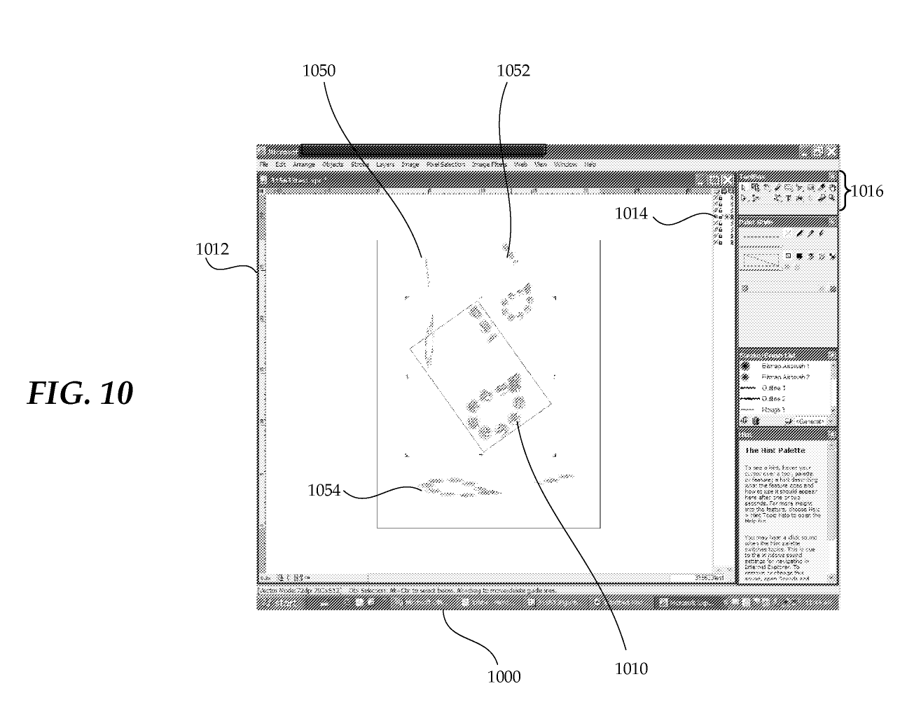

After conversion of the graphic, the selector 124 of FIG. 1 may select the appropriate editor for the converted graphic and may be displayed to the user in any suitable manner for manipulation, such as through the appropriate editor and/or graphics generator. For example, as shown in the example display 1000 of FIG. 10, the converted current graphic (vector object 1010) based on the modified basis pixel data 910 of FIG. 9 may be displayed to the user in a frame 1012 of the selected vector mode layer 1014. The current vector object 1010 reflects the changes made to the basis pixel data (e.g., erasure of pixels) but retains the vector manipulations performed on the vector object prior to the modification to the basis pixel data.

In response to the return to the current graphics type and mode, i.e., vector mode in the example of vector object 1010, the selector 124 of FIG. 1 may automatically select the appropriate editor matching the mode of the layer (and current graphics type) to provide the appropriate manipulation environment for the user. For example, as shown in FIG. 10, the frame 1012 provides a vector mode editing environment through the vector editor 128 of FIG. 1. In response to the current graphic indicator, the editor, such as the vector editor may provide the appropriate tools for the converted graphic, which in the case of the current vector object 1010 would be the vector manipulation tools. The graphics manipulation tools may be provided to the user in any suitable manner. For example, as shown in FIG. 1010, the pixel data manipulation toolbox 812 of FIG. 8 is automatically replaced with the vector toolbox 1016 containing the vector manipulation tools. In this manner, the pixel editor and/or vector editor may provide tools which match the graphics type of the selected layer mode as noted above.

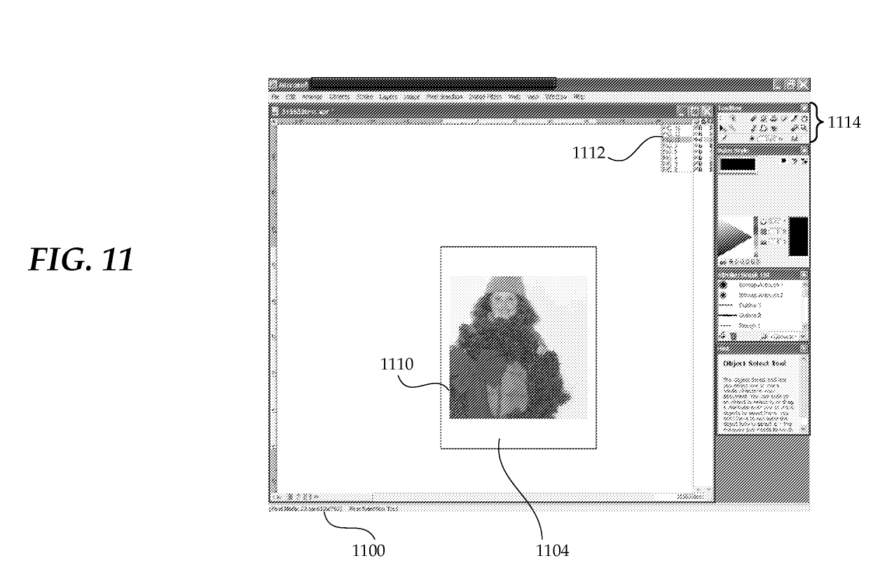

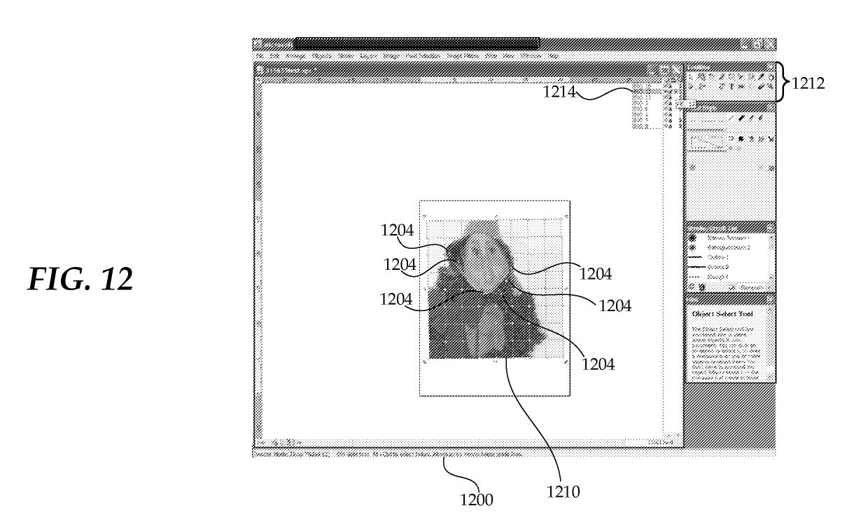

The example display 1100 of FIG. 11 illustrates another example of pixel data, i.e., image 1110. The pixel data 1110 is located in the workspace 1104 of a pixel mode layer indicated by the pixel layer mode identifier 1112 and the pixel toolbox 1114. A user may select one or more of the pixels and transfer the selected pixels (or a copy thereof) into a target layer of a different mode, such as a vector mode layer. In response to transferring of the pixels into a vector layer, the converter 130 of the single graphics design application may be triggered to automatically convert the selected pixels to a vector object to match the mode of the target layer. In the vector layer, the converted target vector object may be manipulated using one or more of the vector tools provided by the vector editor. For example, in the example display 1200 of FIG. 12, the vector object 1210 based on the basis pixel data 1110 of FIG. 11 may be warped using a node manipulation tool to manipulate nodes 1204.

To allow conversion back to the basis graphic (e.g., pixel data 1110), the converter 130 of FIG. 1 may store in the data store 122 the basis pixel data (e.g., plurality of pixels before conversion to the target vector object 1210) and/or other graphics data, such as a listing of vector object manipulations performed or executed on the target vector object 1210 after conversion from the basis pixel data 1110. For example, the data store may store a node identifier for each node moved, the new location of the node, and/or the order that the nodes were moved, and/or any other manipulations performed on the target vector object. Although a single type of node manipulation is illustrated, it is to be appreciated that any number and type of vector object manipulations may be performed on the vector object and stored in any suitable manner.

To modify individual pixels or use pixel tools such as filters and the like, the user may copy the current vector object, i.e., the modified target vector object, back to a pixel mode layer. However, the automatically converted pixel data would include the warped changes in the ‘basis’ vector object. To allow the user to manipulate the basis pixel data, the user may select the vector object 1210 and provide a basis graphic indicator. In response to the basis graphic indicator, the converter 130 of FIG. 1 may automatically convert the selected graphic to the previous basis graphics type (e.g., in the example of FIG. 12, the converter may convert the current vector object 1210 back to the pixel data 1110). For example, the converter 130 of FIG. 1 may retrieve from the data store 122, the manipulations executed against the converted basis pixel data 1110 which resulted in the selected current vector object 1210. In the example of vector object 1210, the data store may retain information indicating that the basis pixel data 1110 was converted to a target vector object, a node grid applied, and nodes 1204 warped to a new location with a warping tool, resulting in the current (displayed) vector object. The converter may then reverse the manipulation process (e.g., undo the vector object manipulations) and convert the vector object to a pixel data to convert the current vector object to the basis pixel data. For example, the converter may take the vector object 1210, move the node 1204 locations to their original positions, and then convert the vector object into pixel data, which should then be identical to the basis pixel data 1110. Alternatively, the converter may examine the vector object and retrieve from the data store the associated basis pixel data for the selected vector object.

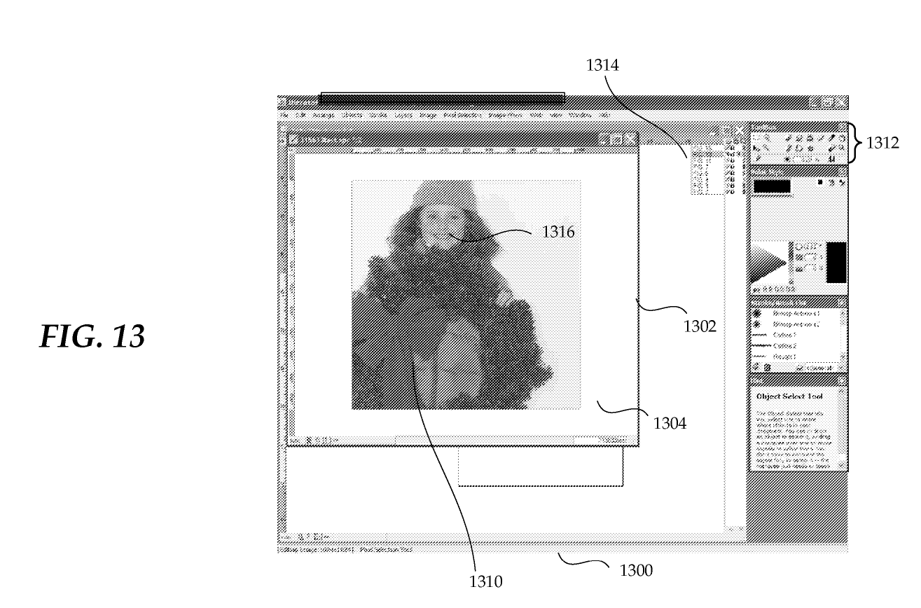

After conversion of the object, the selector 124 of FIG. 1 may select the appropriate editor for the basis graphic and the basis graphic may be displayed to the user in any suitable manner for manipulation, such as through the appropriate editor and/or graphics generator. For example, as shown in the example display 1300 of FIG. 13, the basis pixel data 1310 may be displayed to the user in a basis manipulation frame having a basis manipulation workspace 1304. The basis manipulation frame may provide any suitable display and/or manipulation environment for the user through the selected editor. For example, as shown in FIG. 13, the basis manipulation frame 1302 provides a pixel mode editing environment or layer that may be provided by the pixel editor 126 of FIG. 1.

In response to the basis graphic indicator, the editor, such as the pixel editor, may provide the appropriate tools for the accessed basis graphic, which in the case of the basis pixel data 1310 would be the pixel manipulation tools. The basis graphic manipulation tools may be provided to the user in addition to or instead of the layer mode manipulation tools. For example, as shown in FIG. 13, the pixel manipulation toolbox 1312 containing the pixel manipulation tools replaces the vector object manipulation toolbox 1212 of FIG. 12, even though the active layer is a vector mode layer as indicated by the layer indicator 1214, 1314. In this manner, the pixel editor and/or vector editor may provide tools which match the graphics type of the selected layer mode as noted above and/or the type of an accessed basis graphic which may be different than the mode of the current layer.

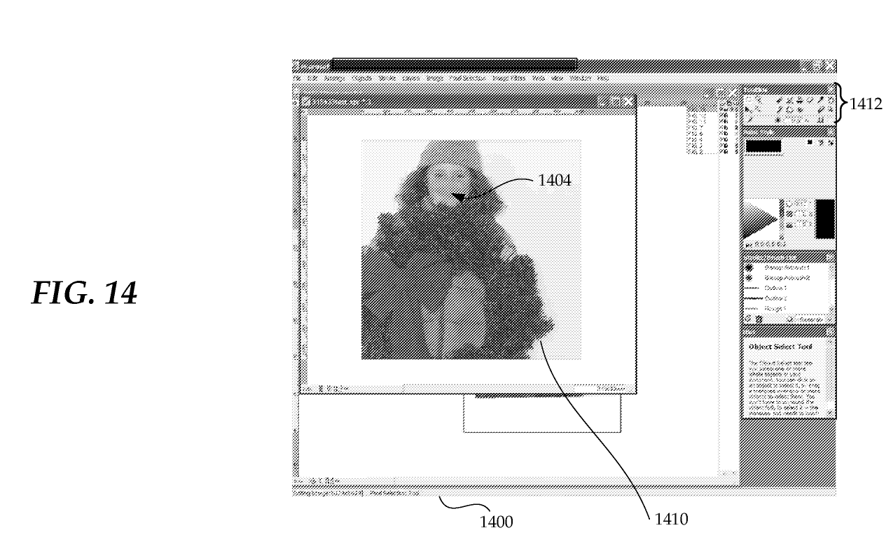

In the basis manipulation frame, the user may manipulate the basis graphic within a mode that is different than the mode of the current layer. For example, the selected layer mode is a vector mode. However, the user may manipulate the accessed basis pixel data as if it was within a pixel mode. For example, as shown in FIG. 13, the user may use the blurring tool over pixels in the mouth area 1316 of the basis pixel data 1310. As result, the basis pixel data 1310 may be modified to the basis pixel data 1410 illustrated in the example display 1400 of FIG. 14.

After access to the basis graphic is completed, the user may provide a current graphic indicator in any suitable manner. As noted above, the current graphic indicator may be any suitable indicator such as selection of the current layer, selection of the current graphic, closing the basis frame, an indication of a modification of the basis graphic, and/or any other suitable indicator. In response to the current graphic indicator, the modified basis graphic may be automatically converted back to the graphics type of the current graphic matching the mode of the active layer in any suitable manner, such as by the converter 130 of FIG. 1. For example, the converter may convert the modified basis graphic to a graphic having a type matching the mode of the current layer (e.g., converting basis pixel data 1410 to a vector object). To convert the modified basis graphic back to the current graphics type, the converter 130 may retrieve from the data store 122, the manipulations executed against the target graphic which resulted in the current graphic (prior to re-accessing the basis graphic through the current graphic). In the example of pixel data 1410 of FIG. 14, the converter may convert the modified basis pixel data 1410 to a vector object and warp the prior selected nodes to the retrieved locations with a vector object manipulation.

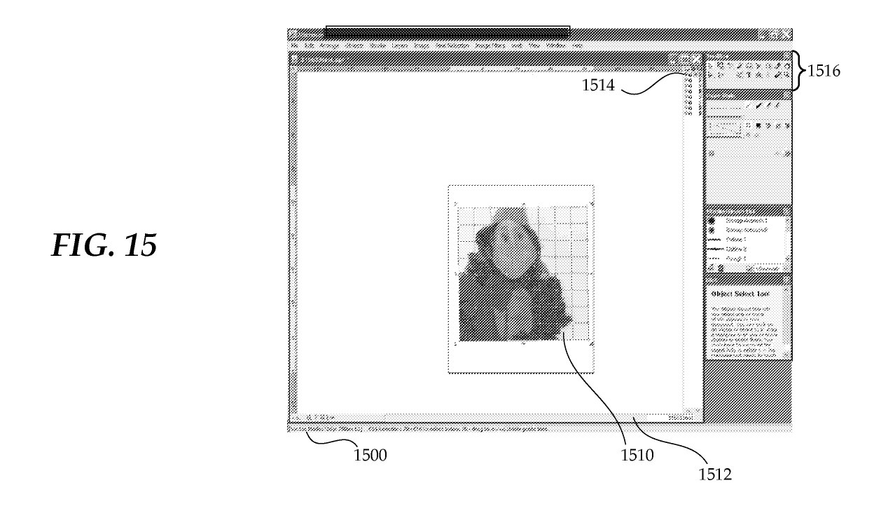

After conversion of the basis graphic back to the current graphic, the selector 124 of FIG. 1 may automatically select the appropriate editor for the converted current object which may be displayed to the user in any suitable manner for manipulation, such as through the appropriate editor and/or graphics generator. For example, as shown in the example display 1500 of FIG. 15, the converted current graphic (vector object 1510) based on the modified basis pixel data 1410 of FIG. 14 may be displayed to the user in a frame 1512 of the selected vector mode layer 1514.

In some cases, the conversion of the bitmap vector object to the basis object may not actually convert the object type. Specifically, converting the target object to the basis object includes accessing pixel data associated with a bitmap vector object. For example, some original pixel data (P) is moved into a vector object editing environment such as a vector layer, the pixel may be automatically converted into a bitmap vector object (V). In some cases, the conversion of the pixel data (P) to the bitmap vector object (V) may include creating a vector object data structure which may include a description of any number and/or combination of the vector object's coordinate frame (T), the vector object attributes (A), list of filters (F) which may be initially empty, potential deformation data (D) which may be initially un-manipulated, and a representation (Q) of the pixel data (P). In this manner, the manipulations to the vector object may include any number or combination of the attributes (A), filters (F), and deformation data (D).

In some cases, the representation (Q) of the pixel data may include some compressed or elaborated form of the original pixel data (P) which may make the pixel data more suitable for display and/or manipulation in a vector object environment. In this example, conversion of the target vector object to the basis image may include accessing the representation (Q) and converting that to the original pixel data, such as by undoing the manipulations to the pixel data that were applied to achieve the representation data (Q). To convert the modified basis pixel data back to a bitmap vector object, the manipulations used to convert the original pixel data to representative data (Q) may be applied to the modified basis data to generate representative data (Q′) of the modified basis pixel data. The manipulations (A, F, D) applied to the bitmap vector object may be retrieved and applied to update the display of the target bitmap vector object with the updated representative data (Q′).

In other cases, the representation (Q) may be the original pixel data (P) itself, i.e., the original pixel data may be stored and/or associated directly with the bitmap vector object. In this case, the conversion of the target bitmap vector object to the basis object may include accessing the pixel data (P) and undoing the manipulations to the original pixel data and/or the manipulations (A, F, D) to the target object may not be required. The basis pixel data may be modified. In this manner, converting the modified basis pixel data back to the target bitmap object includes storing the updated pixel data (P′) in the bitmap vector object data structure and no modification of object type is required. However, to update the display of the target vector object with the updated pixel data, the manipulations (A, F, D) applied to the vector object may be re-applied to the modified pixel data (P′) to update the display of the bitmap vector object.

In response to the return to the current graphics type and mode, e.g., vector mode in the example of vector object 1510, the selector 124 of FIG. 1 may automatically select the appropriate editor matching the mode of the layer (and current graphics type) to provide the appropriate manipulation environment for the user. For example, as shown in FIG. 15, the frame 1512 provides a vector mode editing environment through the vector editor 128 of FIG. 1.

In response to the current graphic indicator, the editor, such as the vector editor, may provide the appropriate tools for the converted graphic, which in the case of the current vector object 1510 would be the vector manipulation tools. The vector object manipulation tools may be provided to the user in any suitable manner. For example, as shown in FIG. 1510, the pixel manipulation toolbox 1412 of FIG. 14 is automatically replaced with the vector toolbox 1516 containing the vector manipulation tools, although it is to be appreciated that both toolboxes may be provided to the user, and moreover, a toolbox associated with the active mode may be indicated to the user in any appropriate manner, such as by graying out inactive tools, providing a mode indicator, and the like. In this manner, the pixel editor and/or vector editor may provide tools which match the object type of the selected layer mode as noted above and/or an accessed basis graphic which may be different than the mode of the current layer.

Although the above examples describe converting a bitmap object to a vector object with access to the basis bitmap object, it is to be appreciated that a bitmap object converted from a vector object may allow access to the basis vector object in a similar manner, such as by storing the basis vector object and/or storing pixel operations performed on the converted pixel data.

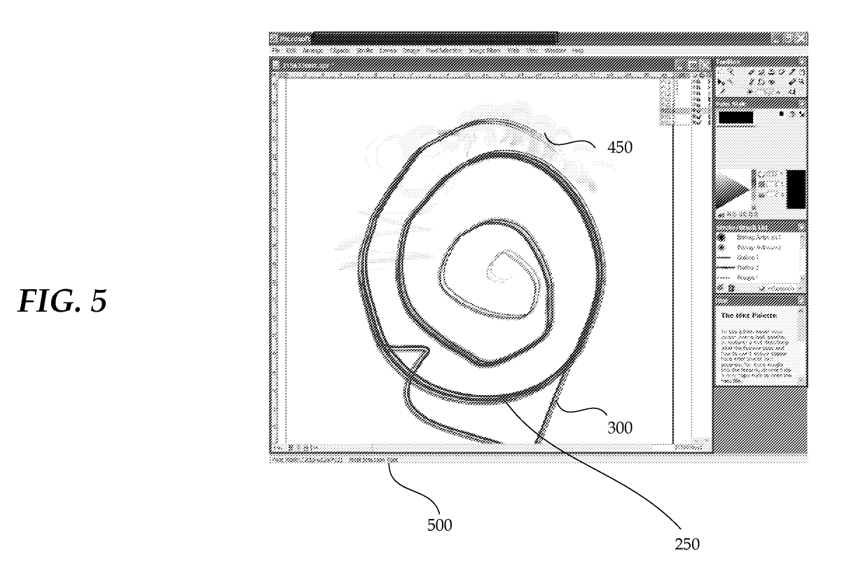

Having a single graphics design application provide both a pixel editor and a vector object editor allows a user to create a compound graphics design in a single document with streamlined and integrated modifications to multiple objects, and/or integrated storage of objects of differing types in a single document and modifiable by a single application. For example, the original vector spiral object 250 of FIG. 2, the modified vector spiral object 300 of FIG. 3, and the modified bitmap spiral object 450 of FIG. 4 may be displayed together in the example display 500 of FIG. 5 as a single document of the single graphics design application 120 of FIG. 1.

Although the example of FIGS. 2 and 3 illustrate the vector objects in separate layers, it is to be appreciated that the graphics design application may allow a plurality of vector objects in a single layer. For example, as shown in FIG. 10, the vector object 1010 based on the modified basis pixel data of FIG. 9 was copied, rotated, and scaled, to create vector object 1052 and vector object 1054, all within the same layer as vector object 1010.

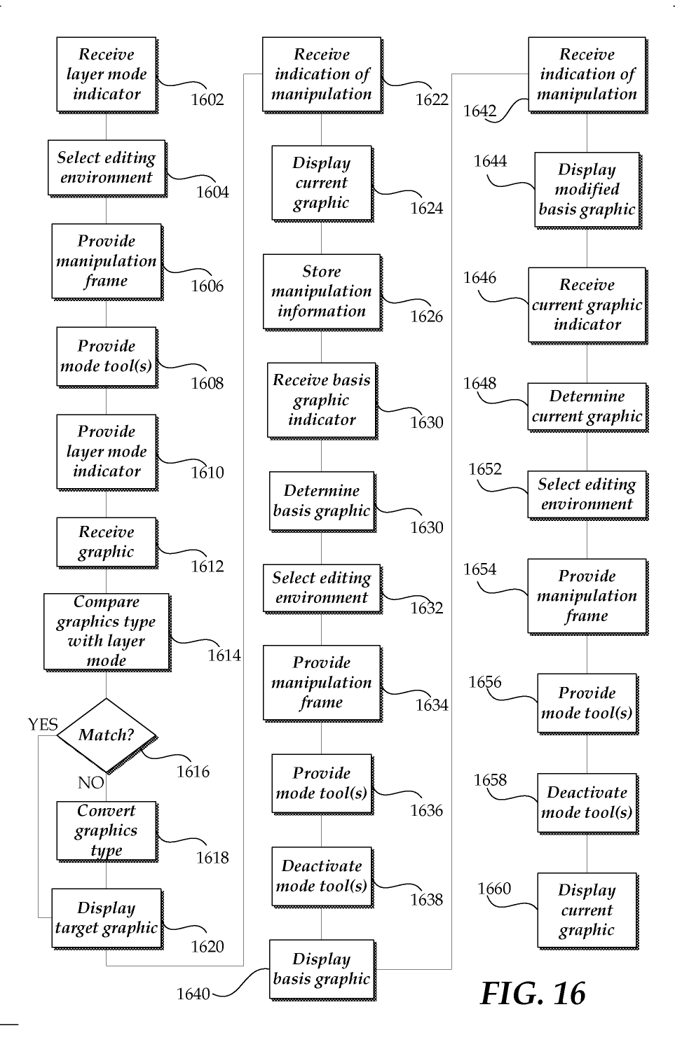

FIG. 16 illustrates an example method for interacting between pixel and vector mode layers as provided by a single graphics design application. The graphics design application may receive 1602 a layer mode indicator indicating the desired mode (e.g., pixel, vector, or any other graphics type) of the layer to create graphics of that mode type. In response to the layer mode indicator, an appropriate editing environment including an editor may be selected 1604, such as by the selector 124 of FIG. 1, to match the layer mode indicator. Based on the layer mode indicator, an appropriate graphic manipulation frame may be provided 1606 to the user to match the layer mode indicator. In response to the layer mode indicator, one or more tools matching the mode indicated by the layer mode indicator may be provided 1608 to the user. For example, if a vector mode is indicated, then vector tools with vector functionalities may be provided to the user; and conversely, if a pixel mode is indicated, then pixel tools with pixel data functionalities may be provided to the user.

In some cases, a layer mode identifier may be provided 1610 to the user. For example, a layer mode identifier may be an icon indicating the layer mode (e.g., the rectangle icon for vector layer and checker icon for pixel layer), an audible signal, background pattern or fill, frame position or style, and/or any other suitable indicator to the user to communicate the mode type.

The single graphics application may receive 1612 a graphic, such as by generation of a graphic within the editing environment or receiving an indication to transfer a graphic into the destination target layer. The graphics design application may compare the type of the received graphic to the mode of the target layer. If the graphics type and mode of the destination layer match 1616, then the received graphic may be displayed 1620 in the target manipulation frame. If the graphics type and mode of the target layer do not match 1616, then the received graphic may be converted 1618 to have a graphics type matching the mode of the target layer. The converted target graphic may then be displayed 1620 in the manipulation frame.

The single graphics design application may receive 1622 an indication of manipulation of the displayed target graphic. For example, the user may use the provided mode tools to modify the target graphic in some manner as appropriate with the mode of that layer. In response to the manipulation indication, the target graphic may be modified by the editor of that layer and the resulting current graphic may be displayed 1624. In response to the manipulation indication, indication of the manipulation performed on the target graphic to create the current graphic may be stored 1626 in any suitable manner, such as associated with the current graphic.

The single graphics design application may receive 1628 a basis graphic indicator indicating that the user wishes to access the basis graphic, which in the initial iteration is the received graphic before it was converted and manipulated in the current layer. As noted above, the basis graphic indication may be any suitable indication such as a double click on the current displayed, a basis graphic accessing tool, a menu option, and the like.

In response to the basis graphic indicator, the single graphics design application may determine 1630 the basis graphic. In some cases, the basis graphic may be retrieved directly from memory. In other cases, the current graphic may be converted to the target graphic and then into the basis graphic by un-doing the manipulation performed on the target graphic using the stored manipulation information, and converting the target graphics type back to the basis graphics type. In other cases, representative pixel data associated with a vector object may be determined and the representative pixel data may be converted back to original pixel data by undoing manipulations to the pixel data.

Based on the basis graphic indicator, the single graphics design application without input from another graphics design application may select 1632 an appropriate editing environment including an editor which matches the graphics type of the determined basis graphic. Based on the basis graphic indicator, the single graphics design application, without input from another graphics design application, may provide 1634 a graphic manipulation frame, which may be tailored to match the type of the basis graphic. Based on the basis graphic indicator, the single graphics application without input from another graphics design application may provide 1636 one or more tools matching the graphics type of the basis graphic. For example, if the basis graphic is a vector object, then vector tools with vector functionalities may be provided to the user; and conversely, if the basis graphic is pixel data, then pixel tools with pixel functionalities may be provided to the user. In some cases, tools which do not match the mode of the basis graphic may be deactivated 1638. Tools and their functionalities that do not match the basis graphics type may be deactivated in any suitable manner, such as by removing those tools from the toolbox, graying out deactivated tools, removing a toolbox, and the like.

The determined basis graphic may be displayed 1640 in the graphic manipulation frame for modification or review by the user. The single graphics design application may receive 1642 (without input from another graphics design application) an indication of manipulation of the basis graphic. For example, the user may use the provided mode tools to modify the basis graphic in some manner as appropriate with the basis graphics type. In response to the manipulation indication, the modified basis graphic may be displayed 1644.

The single graphics design application may receive 1646 a current graphic indicator indicating that the user wishes to return to the destination layer of the current graphic. As noted above, the current graphic indicator may be any suitable indicator such as a double click on the basis graphic, closing of the basis graphic manipulation frame, a menu selection, selecting the frame of the current graphic, and the like.

In response to the current graphic indicator, the single graphics design application (without input from another graphics application) may determine 1648 the current graphic based on the modified basis graphic. The current graphic may be determined from the modified basis graphic in any suitable manner. For example, the current graphic may be determined by converting the basis graphic to have a graphics type identical to the mode of the destination layer, and re-doing the manipulation(s) performed on the target graphic using the stored manipulation information which were associated with the current graphic. In another example, modified basis pixel data may be converted to representative data and stored associated with the bitmap vector object. The display of the current graphic may be updated by re-applying to the modified basis representative data, manipulation(s) which were performed on the target graphic using stored manipulation information.

Based on the current graphic indicator, the single graphics design application without input from another graphics design application may select 1650 an appropriate editing environment including an editor which matches the graphics type of the determined current graphic. Based on the current graphic indicator, the single graphics design application without input from another graphics design application may provide 1652 a graphic manipulation frame, which may be tailored to match the graphics type of the current graphic. Based on the current graphic indicator, the single graphics application without input from another graphics design application may provide 1654 one or more tools matching the graphics type of the current graphic and mode of the destination layer. For example, if the current graphic is a vector object, then vector tools with vector functionalities may be provided to the user; and conversely, if the current graphic is pixel data, then pixel tools with pixel functionalities may be provided to the user. In some cases, tools which do not match the mode of the destination layer may be deactivated 1656 in any suitable manner. The determined current graphic based on the modified basis graphic may be displayed 1660 in the graphic manipulation frame for modification or review by the user and the method may return to receiving an indication of a manipulation 1622 and/or to receiving a layer mode indicator.

While the many embodiments of the invention have been illustrated and described, it will be appreciated that various changes can be made therein without departing from the spirit and scope of the invention.

1. A method comprising:
a) receiving a layer mode indicator indicating a mode of a layer of a single graphics design application, the mode defining a graphics type of a graphic that may be manipulated within the layer;
b) in response to the layer mode indicator, selecting an editor component matching the mode of the layer; and
c) displaying a manipulation frame for manipulating a first type of graphic within the layer, the first type of graphic matching the mode of the layer.

2. The method of claim 1, further comprising displaying one or more mode tools appropriate for manipulating the first type of graphic, the one or more mode tools matching the mode of the layer.

3. The method of claim 2, further comprising deactivating one or more mode tools that are appropriate for manipulating a second type of graphic different that the first type of graphic.

4. The method of claim 1, further comprising providing a layer mode identifier to a user, the layer mode identifier indicating the mode of the layer.

5. The method of claim 1, further comprising receiving a received graphic to be copied into the layer, comparing a second type of graphic of the received graphic with the mode of the layer, and automatically converting the received graphic of a second type to a target object of the first type if the second type of the received graphic is different from the first type of graphic.

6. The method of claim 5, wherein the graphic of the first type of graphic is one of a vector object and pixel data, and the received graphic of a second type is the other one of the vector object and the pixel data.

7. The method of claim 5, further comprising receiving a basis graphic indicator indicating a request for access to the received graphic of the second type, and in response to the basis graphic indicator, converting the target graphic of the first type to a basis graphic of the second type identical to the received graphic.

8. The method of claim 7, further comprising receiving an indication of a manipulation of the target graphic, displaying the manipulated target graphic as a current graphic, and storing the indication of the manipulation in a data store associated with the current graphic.

9. The method of claim 8, wherein converting the target graphic of the first type to a basis graphic includes performing the reverse of the manipulation of the target graphic on the current graphic and converting the type of the reversed current object from the first type to the second type to form the basis graphic.

10. The method of claim 9, further comprising displaying the basis graphic in a manipulation frame for manipulating a graphic of the second type and displaying one or more mode tools that are appropriate for manipulating the second type of graphic.

11. The method of claim 10, further comprising receiving an indication of manipulation of the basis graphic, and in response to a current graphic indicator, converting the manipulated basis graphic of the second type to a modified current graphic of the first type based on the manipulated basis graphic and the manipulation of the target graphic to form the modified current graphic.

12. The method of claim 11, wherein the current graphic indicator is the indication of manipulation of the basis graphic.

13. One or more computer readable media having computer executable components comprising:
a) a data store component for storing manipulation information associated with a displayed current graphic in a single graphics design application;
b) a single graphics design application including:
i) a pixel editor component for providing a pixel data editing environment;
ii) a vector editor component for providing a vector object editing environment;
iii) a selector for receiving a layer mode indicator indicating a mode of a layer of the single graphics design application, the mode defining a graphics type of graphic that may be manipulated within the layer and for selecting, in response to the layer mode indicator, one of the pixel editor and the vector editor for the layer.

14. The computer readable media of claim 13, further comprising a converter component for automatically converting a received graphic from a first graphics type to a target object of a second graphics type to match the mode of the layer.

15. The computer readable media of claim 14, wherein the converter component is triggered to automatically convert the received graphic by reception of an indication to transfer the received graphic into the layer.

16. The computer readable media of claim 14, wherein the converter component is for converting the target object of the second type to a basis graphic identical to the received graphic based on one or more manipulations of the target graphic to form a current graphic, the data store for storing the one or more manipulations associated with the current graphic.

17. The computer readable media of claim 13, wherein the layer is a vector mode layer suitable for containing a plurality of vector objects.

18. A graphics design system comprising:
a) a data store for storing graphic manipulation information associated with a current graphic;
b) a memory in which machine instructions of a graphics design application are stored; and
c) a processor that is coupled to the memory and the data store, the processor executing the machine instructions of the graphics design application to carry out a plurality of functions, the machine instructions including:
i) selecting a pixel editor or a vector editor for a target layer based on a layer mode indicator provided by a user;
ii) receiving a graphic;
iii) automatically converting the received graphic from a vector object to a target pixel data if the layer mode indicator indicates a pixel mode layer; and
iv) automatically converting the received graphic from pixel data to a target vector object if the layer mode indicator indicates a vector mode layer.

19. The graphics design system of claim 18, the machine instructions further comprising examining a received basis graphic indicator indicating a request for access to the received graphic, and in response to the basis graphic indicator, providing a basis graphic identical to the received graphic based on stored information indicating manipulations performed on the target graphic.

20. The graphics design system of claim 19, the machine instructions further comprising displaying a manipulation of the basis graphic, receiving a current graphic indicator indicating a request to access the current graphic, and in response to the current graphic indicator, converting the manipulated basis graphic to a modified current graphic of the first type based on the stored information indicating manipulations performed on the target graphic in the layer.
